(19) United States
(12) Patent Application Publication
(10) Pub. No.: US 2026/0221456 A1
(43) Pub. Date: Jul. 30, 2026

(54) ELECTRODES WITH SOLID LUBRICANT ADDITIVES

(71) Applicant: GM Global Technology Operations LLC, Detroit, MI (US)

(72) Inventors: Mengyuan Chen, Troy, MI (US); Bradley R. Frieberg, Farmington Hills, MI (US); Xiaosong Huang, Novi, MI (US); Xiaowei Yu, Farmington Hills, MI (US); Ming Wang, Sterling Heights, MI (US)

(21) Appl. No.: 19/037,675

(22) Filed: Jan. 27, 2025

(51) Int. Cl. H01M 4/62; H01M 4/02

(52) U.S. Cl. CPC H01M 4/625; H01M 2004/021

(57) ABSTRACT

Aspects of the disclosure include electrodes manufactured with solid lubricant additives to improve calendering processibility. An exemplary vehicle includes an electric motor and a battery pack. The battery pack includes a battery cell that includes an anode current collector, an anode active material layer, a cathode current collector, a cathode active material layer, and a separator positioned between the anode active material layer and the cathode active material layer. The cathode active material layer includes cathode active materials, a solid lubricant additive, and, optionally, a cathode binder, a conductive additive, or both the cathode binder and the conductive additive. The solid lubricant additive includes materials each having a plate-like structure with an aspect ratio of greater than 3. The solid lubricant additive is spaced within the cathode active material layer to define channels within which the cathode active materials, cathode binder, and conductive additive reside.

### INTRODUCTION

The present disclosure relates to battery cell manufacturing, and particularly to electrodes with solid lubricant additives to improve calendering processibility.

It is desirable to improve calendering processibility for lithium-ion batteries. Lithium-ion batteries, also known as lithium-ion cells, are a type of rechargeable battery technology that have gained significant attention due to their relatively high energy density and long cycle life compared to other battery chemistries. The anode (negative electrode) in a lithium-ion cell is typically made of graphite, a carbon-based material that can reversibly intercalate and deintercalate lithium ions. The cathode (positive electrode) can be made of various lithium-containing compounds, such as lithium transition metal oxides (e.g., LiCoO₂, LiNiMnCoO₂, etc.), lithium metal phosphates (e.g., LiFePO₄), or other suitable materials that can reversibly intercalate and deintercalate lithium ions.

The electrodes in a lithium-ion cell are separated by an electrolyte, which is typically a lithium salt dissolved in an organic solvent, a solid polymer or solid-state electrolyte. The electrolyte acts as a medium for lithium ion transport between the anode and cathode during charge and discharge processes. Current collectors provide a conductive pathway for electrons to flow between the electrodes and an external circuit. The current collector for the anode is typically made of copper or a copper alloy, while the current collector for the cathode is typically made of aluminum or an aluminum alloy.

During the discharge process, lithium ions deintercalate from the anode and migrate through the electrolyte to intercalate into the cathode material, while electrons flow through the external circuit to power a device. During charging, this process is reversed, with lithium ions being extracted from the cathode and intercalated back into the anode.

### SUMMARY

In one exemplary embodiment a vehicle includes an electric motor and a battery pack electrically coupled to the electric motor. The battery pack includes a battery cell that includes an anode current collector, an anode active material layer, a cathode current collector, a cathode active material layer, and a separator positioned between the anode active material layer and the cathode active material layer. The cathode active material layer includes cathode active materials, a solid lubricant additive, and, optionally, a cathode binder, a conductive additive, or both the cathode binder and the conductive additive. The solid lubricant additive includes materials each having a plate-like structure with an aspect ratio of greater than 3. The solid lubricant additive is spaced within the cathode active material layer to define channels within which the cathode active materials, cathode binder, and conductive additive reside.

In some embodiments, the solid lubricant additive includes materials each having a plate-like structure with an aspect ratio of greater than 5, or greater than 10, or greater than 20.

In some embodiments, the solid lubricant additive includes one or more of graphene, few-layered graphene, reduced graphene oxide (rGO), and graphene oxide (GO).

In some embodiments, the solid lubricant additive includes a graphene-based material having a surface area of between 100 and 900 m²/g, a thickness of between 0.2 and 500 nm, a lateral diameter of between 1 and 50 um, and a conductivity of between 1,000 and 1,000,000 S/cm in-plane.

In some embodiments, the solid lubricant additive includes a material having a particle size of between 2 and 10 microns, a surface area of between 8 and 25 m²/g, and a conductivity of between 3 and 25 S/cm through-plane and 500 to 1,700 S/cm in-plane.

In some embodiments, a content of the cathode active materials is between 94 and 97.9 percent, a content of the solid lubricant additive is between 0.1 and 3 percent, a content of the conductive additive is between 1 and 4 percent, and a content of the cathode binder is between 1 and 4 percent.

In some embodiments, the cathode active material layer is calendered to a porosity of between 18 and 25 percent.

In another exemplary embodiment a battery cell includes an anode current collector, an anode active material layer, a cathode current collector, a cathode active material layer, and a separator positioned between the anode active material layer and the cathode active material layer. The cathode active material layer includes cathode active materials, a solid lubricant additive, and, optionally, a cathode binder, a conductive additive, or both the cathode binder and the conductive additive. The solid lubricant additive includes materials each having a plate-like structure with an aspect ratio of greater than 3. The solid lubricant additive is spaced within the cathode active material layer to define channels within which the cathode active materials, cathode binder, and conductive additive reside.

In some embodiments, the solid lubricant additive includes materials each having a plate-like structure with an aspect ratio of greater than 5, or greater than 10, or greater than 20.

In some embodiments, the solid lubricant additive includes one or more of graphene, few-layered graphene, rGO, and GO.

In some embodiments, the solid lubricant additive includes a graphene-based material having a surface area of between 100 and 900 m²/g, a thickness of between 0.2 and 500 nm, a lateral diameter of between 1 and 50 um, and a conductivity of between 1,000 and 1,000,000 S/cm in-plane.

In some embodiments, the solid lubricant additive includes a material having a particle size of between 2 and 10 microns, a surface area of between 8 and 25 m²/g, and a conductivity of between 3 and 25 S/cm through-plane and 500 to 1,700 S/cm in-plane.

In some embodiments, a content of the cathode active materials is between 94 and 97.9 percent, a content of the solid lubricant additive is between 0.1 and 3 percent, a content of the conductive additive is between 1 and 4 percent, and a content of the cathode binder is between 1 and 4 percent.

In some embodiments, the cathode active material layer is calendered to a porosity of between 18 and 25 percent.

In yet another exemplary embodiment a method can include forming an anode current collector and forming an anode active material layer in direct contact with a surface of the anode current collector. The anode active material layer includes anode active materials, and, optionally, an anode binder, a conductive additive, or both the anode binder and the conductive additive. The method includes forming a cathode current collector and forming a cathode active material layer in direct contact with a surface of the cathode current collector. The cathode active material layer includes cathode active materials, a solid lubricant additive, and, optionally, a cathode binder, a conductive additive, or both the cathode binder and the conductive additive. The method includes forming a separator positioned between the anode active material layer and the cathode active material layer. The solid lubricant additive includes materials each having a plate-like structure with an aspect ratio of greater than 3. The solid lubricant additive is spaced within the cathode active material layer to define channels within which the cathode active materials, cathode binder, and conductive additive reside.

In some embodiments, the solid lubricant additive includes materials each having a plate-like structure with an aspect ratio of greater than 5, or greater than 10, or greater than 20.

In some embodiments, the solid lubricant additive includes one or more of graphene, few-layered graphene, rGO, and GO.

In some embodiments, the solid lubricant additive includes a graphene-based material having a surface area of between 100 and 900 m²/g, a thickness of between 0.2 and 500 nm, a lateral diameter of between 1 and 50 um, and a conductivity of between 1,000 and 1,000,000 S/cm in-plane.

In some embodiments, the solid lubricant additive includes a material having a particle size of between 2 and 10 microns, a surface area of between 8 and 25 m²/g, and a conductivity of between 3 and 25 S/cm through-plane and 500 to 1,700 S/cm in-plane.

In some embodiments, a content of the cathode active materials is between 94 and 97.9 percent, a content of the solid lubricant additive is between 0.1 and 3 percent, a content of the conductive additive is between 1 and 4 percent, and a content of the cathode binder is between 1 and 4 percent.

In some embodiments, the cathode active material layer is calendered to a porosity of between 18 and 25 percent.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings.

FIG. 1 is a vehicle configured in accordance with one or more embodiments;

FIG. 2 is an example battery cell in accordance with one or more embodiments;

FIG. 3 is an example cathode active material layer of the battery cell of FIG. 2 in accordance with one or more embodiments;

FIG. 4 illustrates a wet manufacturing process for forming electrodes with solid lubricant additives in accordance with one or more embodiments;

FIG. 5 illustrates a dry manufacturing process for forming electrodes with solid lubricant additives in accordance with one or more embodiments; and

FIG. 6 is a flowchart in accordance with one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As the demand for energy storage systems offering higher energy densities, faster charging, and extended operational lifespans increases, driven in part by the proliferation of electric vehicles, significant challenges have been imposed on the materials used in battery cell components. Research and development efforts are continuously directed toward identifying novel materials and manufacturing techniques that can meet escalating demands on battery cells and other energy storage systems.

Some of the challenges in battery manufacturing relate to the calendering processes used to fabricate electrodes. During the calendering process an electrode material is compressed to achieve a desired thickness and density. Usually, this process involves passing the electrode material, typically in the form of a slurry-coated foil, through a series of rollers under high pressure and temperature. The primary objectives of calendering are to enhance the mechanical integrity of the electrode, improve the contact between active materials and conductive additives, and ensure uniform thickness across the electrode.

One of the main challenges associated with the calendering process is the trade-off between achieving high density and maintaining the structural integrity of the electrode. Excessive pressure during calendering can lead to the cracking or delamination of the electrode material, which can compromise the performance and lifespan of the underlying battery. Additionally, achieving uniform compression across the entire electrode surface is difficult, especially for large-format electrodes used in industrial and automotive applications. Variations in thickness can result in uneven current distribution during battery operation, leading to localized heating and suboptimal performance. Another significant limitation of the calendering process is related to the permeability of the electrode. As the electrode material is compressed, its porosity decreases, which can adversely affect the transport of lithium ions and electrolyte within the electrode. Reduced permeability can lead to increased internal resistance and diminished battery performance, particularly at high charge and discharge rates. These issues are particularly problematic for cathode processibility, as cathode electrodes usually include rigid materials that are difficult to compress without causing delamination or excessive internal stresses.

This disclosure introduces the use of positive electrodes having solid lubricant additives that improve calendering processibility. Specifically, solid lubricants having plate-like structures (e.g., graphite plates) are introduced into the electrode medium. As used herein, a “plate-like” structure refers to a structure having a geometric form characterized by a flat, thin, and broad configuration, resembling a plate or sheet. This shape typically has a high aspect ratio (AR), meaning the lateral dimensions (length and width) are significantly larger than the thickness. The plate-like shape allows for the alignment of particles in a layered manner, creating channels or pathways within a material. Without wishing to be bound by theory, it is understood that providing these layered channels within the electrode improves the arrangement and alignment of the active and inactive particles within. In short, the rigid electrode particles tend to rearrange and align to the channeled areas. Moreover, intra-electrode rigid particle stresses are also absorbed by the plate-like lubricants in this configuration. Advantageously, positive electrodes manufactured in this manner have improved porosities, with cathode compressions in particular achieving porosities as low as 20 percent. In other words, with the addition of solid lubricants having plate-like structures as described herein, calendaring processability, especially of cathodes, is largely improved.

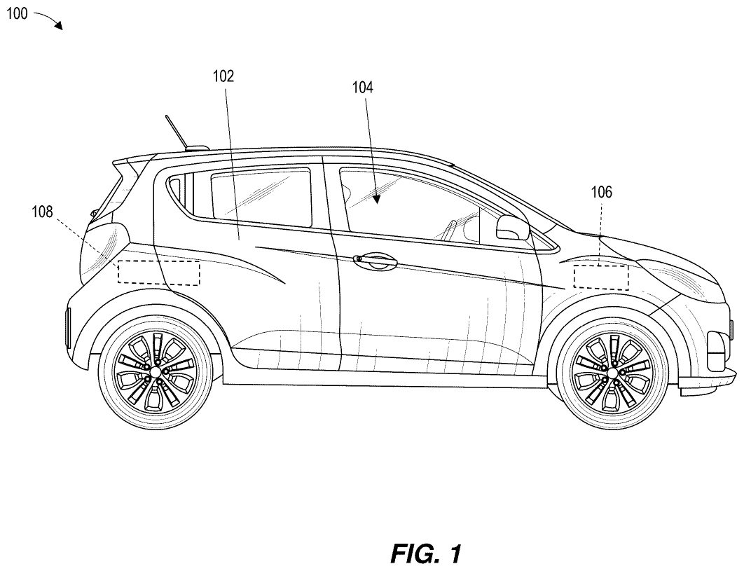

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, an electric motor 106 (shown by projection under the front hood). The electric motor 106 is shown for ease of illustration and discussion only. It should be understood that the configuration, location, size, arrangement, etc., of the electric motor 106 is not meant to be particularly limited, and all such configurations (including multi-motor configurations) are within the contemplated scope of this disclosure.

The electric motor 106 is powered via a battery pack 108 (shown by projection near the rear of the vehicle 100). The battery pack 108 is shown for ease of illustration and discussion only. It should be understood that the configuration, location, size, arrangement, etc., of the battery pack 108 is not meant to be particularly limited, and all such configurations (including split configurations) are within the contemplated scope of this disclosure. Moreover, while the present disclosure is discussed primarily in the context of a battery pack 108 configured for the electric motor 106 of the vehicle 100, aspects described herein can be similarly incorporated within any system (vehicle, building, or otherwise) having an energy storage system(s) (e.g., one or more battery packs or modules), and all such configurations and applications are within the contemplated scope of this disclosure.

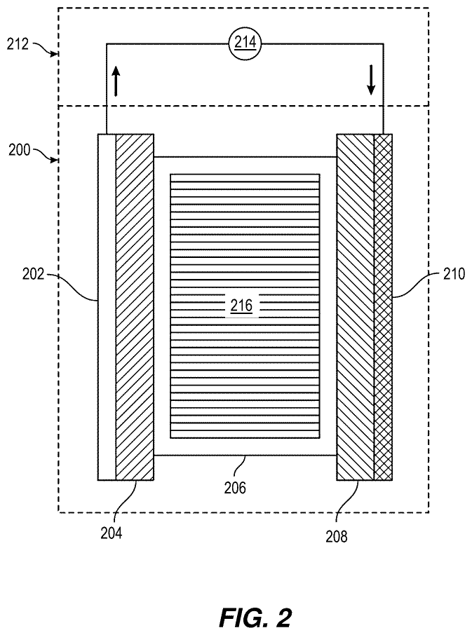

FIG. 2 illustrates an example battery cell 200 in accordance with one or more embodiments. The battery cell 200 can be incorporated as one of a number of battery cells in a battery pack (e.g., the battery pack 108 in FIG. 1). As shown in FIG. 2, the battery cell 200 includes an anode current collector 202, an anode active material layer 204 (the “anode”), a separator 206, a cathode active material layer 208 (the “cathode”), and a cathode current collector 210, configured and arranged as shown.

The anode current collector 202 and the cathode current collector 210 respectively collect and move free electrons to and from an external circuit 212. In some embodiments, external circuit 212 includes a load device 214 (e.g., the electric motor 106 in FIG. 1). In some embodiments, external circuit 212 and load device 214 connect the anode active material layer 204 (through the anode current collector 202, also referred to as the negative electrode) and the cathode active material layer 208 (through the cathode current collector 210, also referred to as the positive electrode). The anode current collector 202 and the cathode current collector 210 can be made of sheets, foils (continuous or with punches or cuts), or mesh of conductive materials. For example, the cathode current collector 210 can be made of aluminum foil, stainless steel, and/or titanium foil. Other materials are possible, such as, for example, semimetals (e.g., tin, graphite) and alloys of the metals and/or semimetals thereof. In some embodiments, the cathode current collector 210 is made of aluminum foil. The anode current collector 202 can include, for example, copper foil and/or one or more graphene layers. In some embodiments, the anode current collector 202 is made of copper foil. The thickness of a current collector can be approximately 10 to 20 μm, although other thicknesses are within the contemplated scope of this disclosure.

The anode active material layer 204 is not meant to be particularly limited, and can include, for example, lithium metal, activated carbon powder, carbon based materials such as graphite, silicon, silicon-based materials such as LiₓSi, SiOₓ, LiSiOₓ, and nano-Si, silicon-graphite composites, tin, tin oxide (SnO₂), tin-cobalt alloys, lithium titanate (Li₄Ti₅O₁₂, LTO), metal alloys such as alloys of two or more of tin, germanium, and cobalt, and combinations thereof. The anode active material layer 204 can further include electrically conductive materials (conductive additives) such as carbon black, graphene, and/or carbon nanotubes. The anode active material layer 204 can further include a binder material such as poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, ethylene propylene diene monomer (EPDM), and combinations thereof. The anode active material layer 204 can include, for example, greater than or equal to about 0 wt. % to less than or equal to about 20 wt. %, and in certain aspects, optionally greater than or equal to about 5 wt. % to less than or equal to about 15 wt. %, of one or more binders.

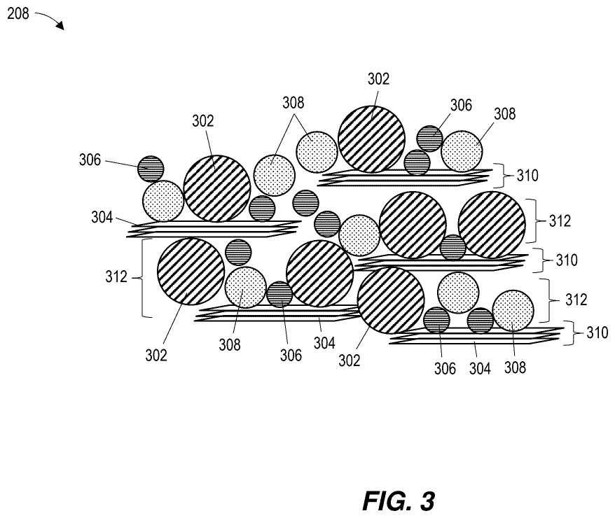

As will be described in greater detail with respect to FIGS. 3, 4, and 5, the cathode active material layer 208 can include a cathode active material(s), a solid lubricant additive(s), one or more conductive additives, and, optionally, a binder. The cathode active material is not meant to be particularly limited, and can include, for example, lithium cobalt oxide (LCO), nickel manganese cobalt oxide (NMC), lithium iron phosphate (LFP), nickel cobalt aluminum oxide (NCA), nickel cobalt manganese aluminum oxide (NCMA), lithium manganese iron phosphate (LMFP), lithium manganese rich (LMR), lithium manganese oxide (LMO), lithium nickel manganese oxide (LNMO), and blends and combinations thereof. The cathode active material content in the cathode active material layer 208 is not meant to be particularly limited, but can include, for example, concentrations of 90 percent or more by weight, for example, 94 to 99 percent, or 96 to 98 percent.

Depending on battery construction (e.g., conventional vs. bi-polar current collectors, etc.) the separator 206 is optional but, if included, can be positioned to isolate the anode active material layer 204 and the cathode active material layer 208. The separator 206 also provides a minimal resistance path for internal passage of lithium ions, and in certain instances, related anions, during cycling of the lithium ions. The separator 206 can include dielectric materials such as, for example, polyethylene (PE), polypropylene (PP), polyethylene terephthalate (PET), synthetic fluoropolymer such as polytetrafluoroethylene (PTFE), and composites thereof, although other dielectrics are within the contemplated scope of this disclosure. In some embodiments, the separator 206 may include a thermally stable coating layer to improve shrinkage behavior (e.g., a porous ceramic coating or porous ester type polymer coating including, for example, polyimide, polyamide, polyimide-polyamide (PI/PA) copolymer, etc.). The thickness of the separator 206 can be approximately 12 to 16 μm, although other thicknesses are within the contemplated scope of this disclosure.

As further shown in FIG. 2, the battery cell 200 includes an electrolyte 216. The electrolyte 216 can include a liquid electrolyte, a solid electrolyte, and/or a polymer electrolyte. In some embodiments, the electrolyte 216 is a liquid electrolyte that permeates, covers, penetrates, or partially penetrates the cathode active material layer 208, the separator 206, and/or the anode active material layer 204. In some embodiments, electrolyte 216 includes a lithium salt dissolved in a solvent, although other liquid electrolytes are possible and all such configurations are within the contemplated scope of this disclosure. The lithium salt chosen in the electrolyte 216 is not meant to be particularly limited and can vary depending on the needs of a given application. In some embodiments, for example, the lithium salt includes lithium hexafluorophosphate (LiPF₆), lithium bis(trifluoromethanesulfonyl)imide (LiTFSI), lithium bis(oxalato)borate (LiBOB), lithium difluoro(oxalato)borate (LiDFOB), lithium bis(fluorosulfonyl)imide (LiFSI), lithium trifluoromethanesulfonate (LiTf), lithium tetrafluoroborate (LiBF₄), lithium nitrate (LiNO₃), and/or lithium bis(pentafluoroethanesulfonyl)imide (LiBETI), and combinations thereof.

The concentration of the lithium salt(s) in the electrolyte 216 will vary depending on the lithium salt(s) chosen and the needs of a given application. The lithium salt concentration can be varied, for example, to target a predetermined ionic conductivity (increasing the salt concentration leads to an increase in ionic conductivity up to a certain point, beyond which the conductivity may decrease due to increased ion-ion interactions and viscosity), to provide suitable levels of salt dissociation and ion mobility (for a given lithium salt, there is a minimum threshold concentration, below which the salt may not fully dissociate, leading to a lack of charge carriers; conversely, there is a maximum threshold concentration, beyond which the increased ion-ion interactions hinder ion mobility sufficiently to reduce conductivity), to provide a target electrolyte viscosity, to target a predetermined electrochemical stability window, and/or to influence the formation and composition of the SEI layer on the lithium metal anode. In some embodiments, the lithium salts can be formed to a concentration of 0.1 M to 2 M, for example, 0.8 M, although other concentrations are within the contemplated scope of this disclosure.

FIG. 3 illustrates an example cathode active material layer 208 of the battery cell 200 of FIG. 2 in accordance with one or more embodiments. As shown in FIG. 3, the cathode active material layer 208 includes active materials 302, solid lubricant additives 304, conductive additives 306, and binders 308. In some embodiments, the active materials 302 are cathode active materials, discussed previously with respect to FIG. 2.

The solid lubricant additive(s) 304 can include synthetic or natural materials having plate-like structures. In some embodiments, the plate-like structures have an aspect ratio (AR) of greater than 3, or 5, or 10, or 20, meaning the lateral dimensions (length and width) are significantly larger than the thickness.

In some embodiments, solid lubricant additive(s) 304 can further include materials having a high crystallinity (that is, the bulk proportion of atoms or molecules are positioned in a regular, periodic lattice with minimal defects and amorphous content), relatively small particle sizes (e.g., less than 20 microns, for example, 2 to 10 microns) with high surface areas (e.g., 100 to 900 m²/g), and high conductivity (e.g., 3 to 25 S/cm through-plane and 500-1700 S/cm in-plane). Example materials include graphene-based materials, such as graphene, few-layered graphene, reduced graphene oxide (rGO), and graphene oxide (GO). Graphene-based materials offer relatively high surface areas (e.g., 100 to 900 m²/g), relatively low thicknesses (e.g., 0.1 to 1000 nm, less than 500 nm, less than 100 nm, less than 10 nm, for example, 0.1 to 1 nm, for example, 0.34 nm), flexible lateral diameters (e.g., 1 to 50 um or longer), and high conductivities (e.g., 10³-10⁶ S/cm in-plane). Other Potential materials are possible, and include molybdenum disulfide (MoS₂) sheets, clay platelets, and hexagonal boron nitride (h-BN) sheets. Molybdenum disulfide is a transition metal dichalcogenide with a plate-like structure that includes layers of molybdenum atoms sandwiched between layers of sulfur atoms, with a thickness of approximately 0.65 nm per layer and lateral dimensions that can range from nanometers to micrometers. Clay platelets, such as montmorillonite and kaolinite, have plate-like particles with thicknesses of a few nanometers and lateral dimensions that can range from tens to hundreds of nanometers. Hexagonal boron nitride sheets offer a plate-like structure similar to graphene and includes layers of boron and nitrogen atoms, with a thickness of approximately 0.33 nm per layer and lateral dimensions that can vary from nanometers to micrometers. The content of the solid lubricant additive(s) 304 in the cathode active material layer 208 is not meant to be particularly limited, but can include, for example, concentrations of 0.1 percent to 3 percent, for example, 1 to 2 percent, by weight.

In some embodiments, the cathode active material layer 208 includes one or more conductive additives 306. Example materials include carbon black (CB), acetylene black (AB), graphene nanoplatelet (GNP), carbon nanofiber (CNF), multi-wall carbon nanotube (MWCNT), single-wall carbon nanotube (SWCNT), or their blends. The content of the conductive additive(s) 306 in the cathode active material layer 208 is not meant to be particularly limited, but can include, for example, concentrations of 1 percent to 4 percent, for example, 1 to 2 percent, by weight.

In some embodiments, the cathode active material layer 208 can include a binder(s) 308. In some embodiments, the binder 308 is a modified high molecular weight binder. In some embodiments, the binder 308 is a modified high molecular weight PVDF binder. In some embodiments, the binder 308 has a molecular weight greater than 800 kDa. The content of the binder(s) 308 in the cathode active material layer 208 is not meant to be particularly limited, but can include, for example, concentrations of 1 percent to 4 percent, for example, 1.5 to 2.5 percent, by weight.

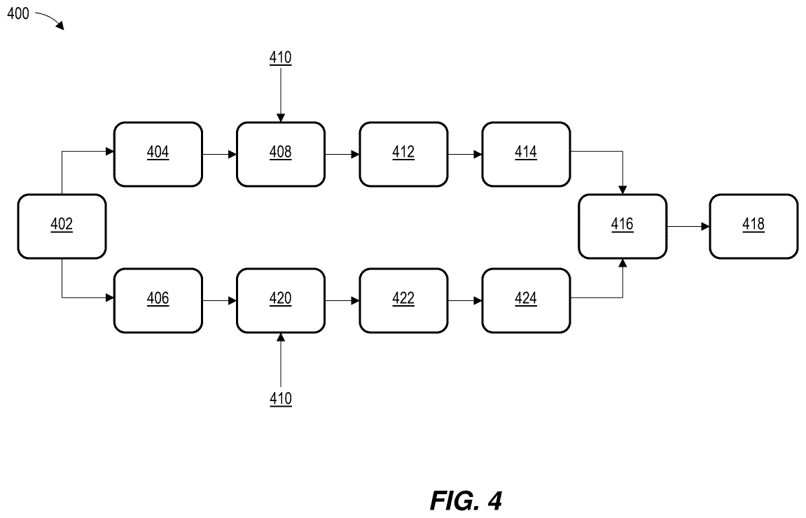

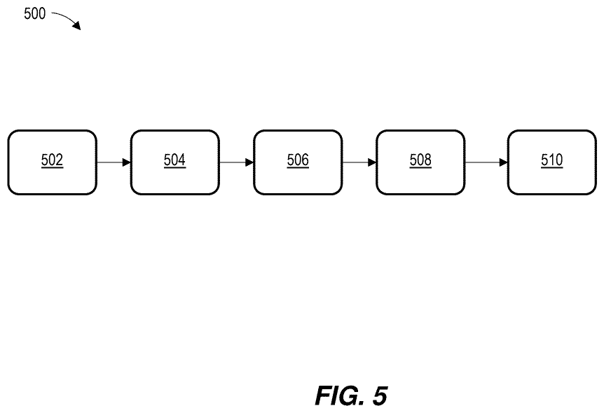

As further shown in FIG. 3, the solid lubricant additive(s) 304 can be arranged in layered, plate-like structures 310. In some embodiments, the plate-like structures 310 are spaced to define channels 312 within which the active materials 302, conductive additives 306, and binders 308 are arranged. The cooperative orientation of the plate-like structures 310 and channels 312 improves intra-electrode particle alignment and reduces rigid particle stresses. Advantagiously, this improved alignment and stress reduction allows the cathode active material layer 208 to be compressed, during a calendering process (refer, e.g., to FIGS. 4 and 5), to porosities as low as 20 percent.

FIG. 4 illustrates a wet manufacturing process 400 for forming electrodes (e.g., the cathode active material layer 208 of FIG. 2) with solid lubricant additives 304 (refer to FIG. 3) to improve calendering processibility in accordance with one or more embodiments. As shown in FIG. 4, the manufacturing process 400 beings with step 402.

During step 402, a binder (e.g., binder 308, refer to FIG. 3) is dissolved in a solvent to create a homogeneous solution that will serve as the foundation for the electrode slurry. This process begins by selecting an appropriate solvent that can effectively dissolve the binder material. Common solvents used for this purpose include N-methyl-2-pyrrolidone (NMP), dimethylformamide (DMF), or other suitable organic solvents known for their ability to dissolve polymeric binders. The binder, which could be a high molecular weight polyvinylidene fluoride (PVDF) or another suitable polymer, is measured and gradually added to the solvent under continuous stirring. Stirring ensures that the binder particles are evenly dispersed throughout the solvent, preventing clumping and promoting uniform dissolution. The mixture is typically stirred at a controlled temperature to enhance the dissolution process. For instance, the solution may be heated to a temperature range of 50 to 80 degrees Celsius, depending on the thermal stability of the chosen binder and the solvent's boiling point. This controlled heating helps to accelerate the dissolution process by increasing the kinetic energy of the molecules, thereby facilitating the interaction between the binder and the solvent. The stirring speed can also be optimized to ensure thorough mixing without introducing excessive air bubbles, which could affect the quality of the final slurry. As the binder dissolves, the solution gradually becomes more viscous, indicating that the polymer chains are fully interacting with the solvent molecules. The dissolution process is monitored until a clear, homogeneous solution is achieved, with no visible undissolved binder particles. This homogeneous binder solution is crucial for the subsequent steps in the electrode fabrication process, as it ensures that the binder is evenly distributed throughout the electrode slurry, providing consistent mechanical properties and adhesion in the final electrode. Once the binder is fully dissolved, the solution is allowed to cool to room temperature while maintaining gentle stirring to prevent any precipitation or phase separation.

After step 402, the wet manufacturing process 400 proceeds to one of step 404 or step 406. The process including step 404 will be discussed first, with a discussion of the process including step 406 to follow.

At step 404, conductive additives (e.g., conductive additives 306 of FIG. 3), such as conductive carbon, are added to the binder-solvent mixture to enhance the electrical conductivity of the electrode. Step 404 begins by selecting a desired conductive additive(s) and then gradually introducing the conductive additive(s) into the binder-solvent mixture under continuous stirring to a desired concentration. This gradual addition helps to prevent agglomeration and ensures that the conductive particles are evenly dispersed throughout the mixture. The mixture is typically stirred at a controlled speed to achieve thorough mixing without introducing excessive air bubbles, which could negatively impact the quality of the final electrode. In some cases, ultrasonic agitation or high-shear mixing techniques may be employed to further enhance the dispersion of the conductive additives. As the conductive additives are incorporated into the binder-solvent mixture, the viscosity of the solution may increase. This change in viscosity is monitored to ensure that the mixture remains workable and suitable for subsequent processing steps. The goal is to achieve a homogeneous slurry where the conductive additives are well-dispersed, forming a continuous conductive network that will enhance the electrical performance of the electrode. Once the conductive additives are fully integrated into the binder-solvent mixture, the resulting slurry is allowed to stabilize. This stabilization period ensures that any remaining air bubbles are released and that the conductive network is uniformly established. After this process completes, the wet manufacturing process 400 proceeds to step 408.

At step 408, solid lubricants (e.g., solid lubricant additives 304 of FIG. 3), such as graphene, are added to the binder-solvent-conductive carbon mixture to improve the calendering processibility and overall performance of the electrode. Step 408 begins by gradually introducing a desired solid lubricant additive(s) into the binder-solvent mixture under continuous stirring to a desired concentration. This gradual addition helps to prevent agglomeration and ensures that the solid lubricant particles are evenly dispersed throughout the mixture. The mixture is typically stirred at a controlled speed to achieve thorough mixing without introducing excessive air bubbles, which could negatively impact the quality of the final electrode. In some cases, ultrasonic agitation or high-shear mixing techniques may be employed to further enhance the dispersion of the solid lubricants. As the solid lubricants are incorporated into the binder-solvent mixture, the viscosity of the solution may increase. This change in viscosity is monitored to ensure that the mixture remains workable and suitable for subsequent processing steps. The goal is to achieve a homogeneous slurry where the solid lubricants are well-dispersed, forming a continuous network that will enhance the mechanical and electrical properties of the electrode. Once the solid lubricants are fully integrated into the binder-solvent mixture, the resulting slurry is allowed to stabilize. This stabilization period ensures that any remaining air bubbles are released and that the solid lubricant network is uniformly established.

Optionally, during this process, additional solvent 410 can be incorporated within the mixture. Additional solvent 410 can be added to target any desired solids content in the slurry or final electrode. For example, in some embodiments, solvent is added to the slurry to achieve a solids content of 45 to 65 percent by weight (or more specifically, 55 to 65 percent by weight). The solvent itself can vary as desired, but can include, for example, N-methyl pyrollidone (NMP). In any case, after step 408 completes, the wet manufacturing process 400 proceeds to step 412.

At step 412, active material (e.g., active materials 302 of FIG. 3), such as LCO, NMC, NCA, LFP, LMO, LTO, etc., are added to the aggregate slurry mixture. In some embodiments, step 412 begins by determining a desired amount of active material (e.g., to achieve a target composition and/or performance characteristics of the final electrode) and then incorporating the active material into the slurry mixture under continuous stirring. The active material is often, although not necessarily, in powder form. The mixture is typically stirred at a controlled speed to prevent the formation of agglomerates and to ensure thorough mixing. In some cases, high-shear mixing or ultrasonic agitation may be employed to enhance the dispersion of the active material particles. After step 412 completes, the wet manufacturing process 400 proceeds to step 414.

At step 414, solvent can be incorporated within the slurry mixture to adjust the solids content as desired. For example, in some embodiments, solvent is added to the slurry to achieve a solids content of 45 to 65 percent by weight (or more specifically, 55 to 65 percent by weight). After step 414 completes, the wet manufacturing process 400 proceeds to step 416.

During step 416, the slurry, which now contains the binder, conductive additives, solid lubricants, and active materials, is coated onto a current collector and allowed to dry. In some embodiments, step 416 begins by selecting and preparing an appropriate current collector material, which is typically a metal foil such as aluminum for the cathode or copper for the anode. In some embodiments, the current collector is cleaned and pre-treated to ensure good adhesion of the slurry. In some embodiments, the slurry is then applied to the current collector using a coating technique such as doctor blade coating, slot-die coating, or a similar method. The coating process involves spreading the slurry evenly across the surface of the current collector to achieve a uniform thickness. The thickness of the coated layer is carefully controlled to meet the desired specifications for the electrode, which can vary depending on the application and performance requirements.

Once the slurry is coated onto the current collector, the coated substrate is subjected to a drying process to remove the solvent and solidify the electrode material. The drying process can be carried out in a convection oven, vacuum oven, or other suitable drying equipment. The temperature and duration of the drying process are optimized to ensure complete solvent removal without degrading the binder or active materials. Typically, the drying temperature ranges from 80° C. to 120° C., and the drying time can vary from a minute to several hours, depending on the solvent and the thickness of the coated layer. During drying, the solvent evaporates, leaving behind a solid electrode layer that is firmly adhered to the current collector. The drying process also helps to further stabilize the distribution of the active materials, conductive additives, and solid lubricants within the binder matrix. The result is a cohesive and mechanically robust electrode with a uniform composition and structure.

After drying, the wet manufacturing process 400 proceeds to step 418. During step 418, the coated electrode undergoes additional processing steps such as calendaring, where the electrode is compressed to achieve a desired density and porosity. This step further enhances the mechanical integrity and electrochemical performance of the electrode. As discussed previously, the incorporation of the solid lubricant additive(s) 304 (refer to FIG. 3) increases the stability of the resulting electrode, allowing for cathode electrode porosities of 20 percent (e.g., from 15 to 25 percent, or from 15 to 20 percent, or from 19 to 21 percent).

Returning now to step 406, in some embodiments, solid lubricants (e.g., solid lubricant additives 304 of FIG. 3), such as graphene, are added to the binder-solvent mixture to improve the calendering processibility and overall performance of the electrode. Step 406 begins by gradually introducing a desired solid lubricant additive(s) into the binder-solvent mixture under continuous stirring to a desired concentration. This gradual addition helps to prevent agglomeration and ensures that the solid lubricant particles are evenly dispersed throughout the mixture. The mixture is typically stirred at a controlled speed to achieve thorough mixing without introducing excessive air bubbles, which could negatively impact the quality of the final electrode. In some cases, ultrasonic agitation or high-shear mixing techniques may be employed to further enhance the dispersion of the solid lubricants. As the solid lubricants are incorporated into the binder-solvent mixture, the viscosity of the solution may increase. This change in viscosity is monitored to ensure that the mixture remains workable and suitable for subsequent processing steps. The goal is to achieve a homogeneous slurry where the solid lubricants are well-dispersed, forming a continuous network that will enhance the mechanical and electrical properties of the electrode. Once the solid lubricants are fully integrated into the binder-solvent mixture, the resulting slurry is allowed to stabilize. This stabilization period ensures that any remaining air bubbles are released and that the solid lubricant network is uniformly established.

After step 406, conductive additives (e.g., conductive additives 306 of FIG. 3), such as conductive carbon, are added to the binder-solvent-solid lubricant mixture at step 420. Step 420 begins by selecting a desired conductive additive(s) and then gradually introducing the conductive additive(s) into the binder-solvent mixture under continuous stirring to a desired concentration. This gradual addition helps to prevent agglomeration and ensures that the conductive particles are evenly dispersed throughout the mixture. The mixture is typically stirred at a controlled speed to achieve thorough mixing without introducing excessive air bubbles, which could negatively impact the quality of the final electrode. In some cases, ultrasonic agitation or high-shear mixing techniques may be employed to further enhance the dispersion of the conductive additives.

Optionally, during this process, additional solvent 410 can be incorporated within the mixture. Additional solvent 410 can be added to target any desired solids content in the slurry or final electrode. For example, in some embodiments, solvent is added to the slurry to achieve a solids content of 45 to 65 percent by weight (or more specifically, 55 to 65 percent by weight). The solvent itself can vary as desired, but can include, for example, N-methyl pyrollidone (NMP). In any case, after step 420 completes, the wet manufacturing process 400 proceeds to steps 422 and 424.

At step 422, active material (e.g., active materials 302 of FIG. 3), such as LCO, NMC, NCA, LFP, LMO, LTO, etc., are added to the aggregate slurry mixture in a similar manner as described with respect to step 412. At step 424, solvent can be incorporated within the slurry mixture to adjust the solids content as desired in a similar manner as described with respect to step 414. After step 424 completes, the wet manufacturing process 400 proceeds to step 416 and the process continues as previously described.

FIG. 5 illustrates a dry manufacturing process 500 for forming electrodes (e.g., the cathode active material layer 208 of FIG. 2) with solid lubricant additives 304 (refer to FIG. 3) to improve calendering processibility in accordance with one or more embodiments. As shown in FIG. 5, the manufacturing process 500 beings with step 502.

At step 502, binders, conductive additives, solid lubricant additives, and active material powders are mixed to form a homogeneous dry powder mixture. In some embodiments, dry mixing continues as desired until a uniform consistency is achieved with most of the conductive additives are coated onto active material surfaces. In some embodiments, intensive shear mixing is preferred for dry powder mixing, although other dry mixing processes are possible and within the contemplated scope of this disclosure. The dry mixing process can be carried out under controlled conditions to prevent the formation of agglomerates and to achieve a uniform consistency. The goal is to ensure that the conductive additives are well-dispersed and that most of the conductive additives are coated onto the surfaces of the active material particles. Notably, the active materials are pre-mixed with solid lubricants during this process. While not required, pre-mixing active materials with solid lubricants in this manner tends to maximize the flowability of the active materials, thereby improving the efficiency of the subsequent dry powder mixing process.

After step 502, the dry manufacturing process 500 proceeds to step 504. During step 504, optionally, additional pre-dispersed conductive additives can be introduced into the dry mixture. In some embodiments, the pre-dispersed conductive additives include a pre-dispersed CNT solution.

In some embodiments, step 504 and step 506 occur together. During step 506, solvent is added to the dry mixture. In some embodiments, the solvent and/or the pre-dispersed conductive additives (e.g., pre-dispersed CNT solution) are added to the dry mixture until a dough-like consistency is achieved. In some embodiments, solvent is added to dilute of the slurry to a target viscosity.

After step 506, the dry manufacturing process 500 proceeds to step 508. During step 508, the slurry, which now contains the binder, conductive additives, solid lubricants, and active materials, is coated onto a current collector and allowed to dry. In some embodiments, step 508 begins by selecting and preparing an appropriate current collector material, which is typically a metal foil such as aluminum for the cathode or copper for the anode. In some embodiments, the current collector is cleaned and pre-treated to ensure good adhesion of the slurry. In some embodiments, the slurry is then applied to the current collector using a coating technique such as doctor blade coating, slot-die coating, or a similar method. The coating process involves spreading the slurry evenly across the surface of the current collector to achieve a uniform thickness. The thickness of the coated layer is carefully controlled to meet the desired specifications for the electrode, which can vary depending on the application and performance requirements.

Once the slurry is coated onto the current collector, the coated substrate is subjected to a drying process to remove the solvent and solidify the electrode material. The drying process can be carried out in a convection oven, vacuum oven, or other suitable drying equipment. The temperature and duration of the drying process are optimized to ensure complete solvent removal without degrading the binder or active materials. Typically, the drying temperature ranges from 80° C. to 120° C., and the drying time can vary from a minute to several hours, depending on the solvent and the thickness of the coated layer. During drying, the solvent evaporates, leaving behind a solid electrode layer that is firmly adhered to the current collector. The drying process also helps to further stabilize the distribution of the active materials, conductive additives, and solid lubricants within the binder matrix. The result is a cohesive and mechanically robust electrode with a uniform composition and structure.

After drying, the dry manufacturing process 500 proceeds to step 510. During step 510, the coated electrode undergoes additional processing steps such as calendaring, where the electrode is compressed to achieve a desired density and porosity. This step further enhances the mechanical integrity and electrochemical performance of the electrode. As discussed previously, the incorporation of the solid lubricant additive(s) 304 (refer to FIG. 3) increases the stability of the resulting electrode, allowing for cathode electrode porosities of 20 percent (e.g., from 15 to 25 percent, or from 15 to 20 percent, or from 19 to 21 percent).

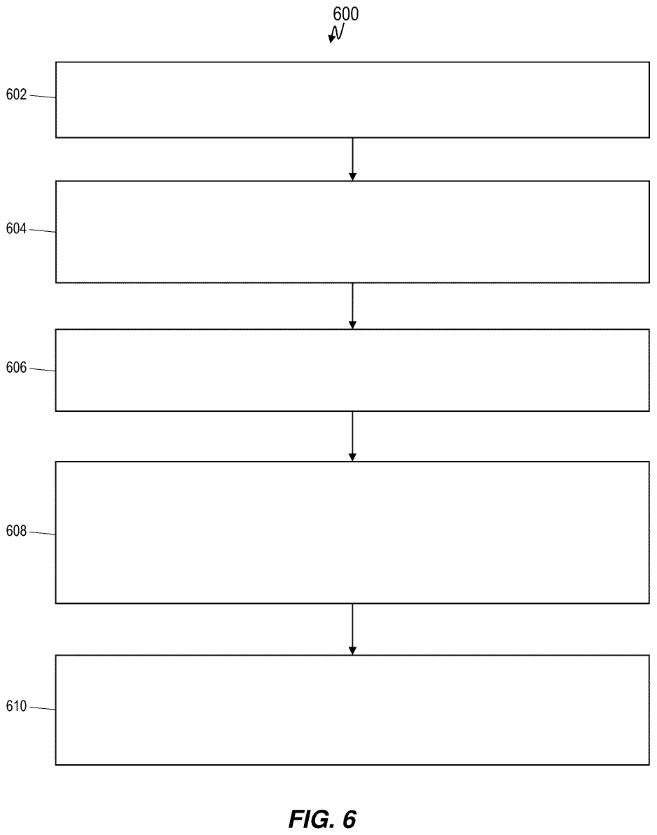

Referring now to FIG. 6, a flowchart 600 for leveraging electrodes with solid lubricant additives to improve calendering processibility is generally shown according to an embodiment. The flowchart 600 is described in reference to FIGS. 1-5 and may include additional steps not depicted in FIG. 6. Although depicted in a particular order, the blocks depicted in FIG. 6 can be rearranged, subdivided, and/or combined.

At block 602, the method includes forming an forming an anode current collector.

At block 604, the method includes forming an anode active material layer in direct contact with a surface of the anode current collector. The anode active material layer includes anode active materials, and, optionally, an anode binder, a conductive additive, or both the anode binder and the conductive additive.

At block 606, the method includes forming a cathode current collector.

At block 608, the method includes forming a cathode active material layer in direct contact with a surface of the cathode current collector. The cathode active material layer includes cathode active materials, a solid lubricant additive, and, optionally, a cathode binder, a conductive additive, or both the cathode binder and the conductive additive.

In some embodiments, the solid lubricant additive includes materials each having a plate-like structure with an aspect ratio of greater than 3. In some embodiments, the solid lubricant additive is spaced within the cathode active material layer to define channels within which the cathode active materials, cathode binder, and conductive additive reside.

At block 610, the method includes forming a separator positioned between the anode active material layer and the cathode active material layer.

In some embodiments, the solid lubricant additive includes materials each having a plate-like structure with an aspect ratio of greater than 5, or greater than 10, or greater than 20.

In some embodiments, the solid lubricant additive includes one or more of graphene, few-layered graphene, rGO, and GO.

In some embodiments, the solid lubricant additive includes a graphene-based material having a surface area of between 100 and 900 m²/g, a thickness of between 0.2 and 500 nm, a lateral diameter of between 1 and 50 um, and a conductivity of between 1,000 and 1,000,000 S/cm in-plane.

In some embodiments, the solid lubricant additive includes a material having a particle size of between 2 and 10 microns, a surface area of between 8 and 25 m²/g, and a conductivity of between 3 and 25 S/cm through-plane and 500 to 1,700 S/cm in-plane.

In some embodiments, a content of the cathode active materials is between 94 and 97.9 percent, a content of the solid lubricant additive is between 0.1 and 3 percent, a content of the conductive additive is between 1 and 4 percent, and a content of the cathode binder is between 1 and 4 percent.

In some embodiments, the cathode active material layer is calendered to a porosity of between 18 and 25 percent.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
an electric motor; and
a battery pack electrically coupled to the electric motor, the battery pack comprising a plurality of battery cells, each battery cell of the plurality of battery cells comprising:
an anode current collector;
an anode active material layer in direct contact with a surface of the anode current collector, the anode active material layer comprising anode active materials, and, optionally, an anode binder, a conductive additive, or both the anode binder and the conductive additive;
a cathode current collector;
a cathode active material layer in direct contact with a surface of the cathode current collector, the cathode active material layer comprising cathode active materials, a solid lubricant additive, and, optionally, a cathode binder, a conductive additive, or both the cathode binder and the conductive additive; and
a separator positioned between the anode active material layer and the cathode active material layer;
wherein the solid lubricant additive includes materials each having a plate-like structure with an aspect ratio of greater than 3; and
wherein the solid lubricant additive is spaced within the cathode active material layer to define channels within which the cathode active materials, cathode binder, and conductive additive reside.

2. The vehicle of claim 1, wherein the solid lubricant additive includes materials each having a plate-like structure with an aspect ratio of greater than 5, or greater than 10, or greater than 20.

3. The vehicle of claim 1, wherein the solid lubricant additive includes one or more of graphene, few-layered graphene, reduced graphene oxide (rGO), and graphene oxide (GO).

4. The vehicle of claim 3, wherein the solid lubricant additive comprises a graphene-based material having a surface area of between 100 and 900 m²/g, a thickness of between 0.2 and 500 nm, a lateral diameter of between 1 and 50 um, and a conductivity of between 1,000 and 1,000,000 S/cm in-plane.

5. The vehicle of claim 1, wherein the solid lubricant additive includes a material having a particle size of between 2 and 10 microns, a surface area of between 8 and 25 m²/g, and a conductivity of between 3 and 25 S/cm through-plane and 500 to 1,700 S/cm in-plane.

6. The vehicle of claim 1, wherein a content of the cathode active materials is between 94 and 97.9 percent, a content of the solid lubricant additive is between 0.1 and 3 percent, a content of the conductive additive is between 1 and 4 percent, and a content of the cathode binder is between 1 and 4 percent.

7. The vehicle of claim 1, wherein the cathode active material layer is calendered to a porosity of between 18 and 25 percent.

8. A battery cell comprising:
an anode current collector;
an anode active material layer in direct contact with a surface of the anode current collector, the anode active material layer comprising anode active materials, and, optionally, an anode binder, a conductive additive, or both the anode binder and the conductive additive;
a cathode current collector;
a cathode active material layer in direct contact with a surface of the cathode current collector, the cathode active material layer comprising cathode active materials, a solid lubricant additive, and, optionally, a cathode binder, a conductive additive, or both the cathode binder and the conductive additive; and
a separator positioned between the anode active material layer and the cathode active material layer;
wherein the solid lubricant additive includes materials each having a plate-like structure with an aspect ratio of greater than 3; and
wherein the solid lubricant additive is spaced within the cathode active material layer to define channels within which the cathode active materials, cathode binder, and conductive additive reside.

9. The battery cell of claim 8, wherein the solid lubricant additive includes materials each having a plate-like structure with an aspect ratio of greater than 5, or greater than 10, or greater than 20.

10. The battery cell of claim 8, wherein the solid lubricant additive includes one or more of graphene, few-layered graphene, reduced graphene oxide (rGO), and graphene oxide (GO).

11. The battery cell of claim 10, wherein the solid lubricant additive comprises a graphene-based material having a surface area of between 100 and 900 m²/g, a thickness of between 0.2 and 500 nm, a lateral diameter of between 1 and 50 um, and a conductivity of between 1,000 and 1,000,000 S/cm in-plane.

12. The battery cell of claim 8, wherein the solid lubricant additive includes a material having a particle size of between 2 and 10 microns, a surface area of between 8 and 25 m²/g, and a conductivity of between 3 and 25 S/cm through-plane and 500 to 1,700 S/cm in-plane.

13. The battery cell of claim 8, wherein a content of the cathode active materials is between 94 and 97.9 percent, a content of the solid lubricant additive is between 0.1 and 3 percent, a content of the conductive additive is between 1 and 4 percent, and a content of the cathode binder is between 1 and 4 percent.

14. The battery cell of claim 8, wherein the cathode active material layer is calendered to a porosity of between 18 and 25 percent.

15. A method comprising:
forming an anode current collector;
forming an anode active material layer in direct contact with a surface of the anode current collector, the anode active material layer comprising anode active materials, and, optionally, an anode binder, a conductive additive, or both the anode binder and the conductive additive;
forming a cathode current collector;
forming a cathode active material layer in direct contact with a surface of the cathode current collector, the cathode active material layer comprising cathode active materials, a solid lubricant additive, and, optionally, a cathode binder, a conductive additive, or both the cathode binder and the conductive additive; and
forming a separator positioned between the anode active material layer and the cathode active material layer;
wherein the solid lubricant additive includes materials each having a plate-like structure with an aspect ratio of greater than 3; and
wherein the solid lubricant additive is spaced within the cathode active material layer to define channels within which the cathode active materials, cathode binder, and conductive additive reside.

16. The method of claim 15, wherein the solid lubricant additive includes materials each having a plate-like structure with an aspect ratio of greater than 5, or greater than 10, or greater than 20.

17. The method of claim 15, wherein the solid lubricant additive comprises a graphene-based material having a surface area of between 100 and 900 m²/g, a thickness of between 0.2 and 500 nm, a lateral diameter of between 1 and 50 um, and a conductivity of between 1,000 and 1,000,000 S/cm in-plane.

18. The method of claim 15, wherein the solid lubricant additive includes a material having a particle size of between 2 and 10 microns, a surface area of between 8 and 25 m²/g, and a conductivity of between 3 and 25 S/cm through-plane and 500 to 1,700 S/cm in-plane.

19. The method of claim 15, wherein a content of the cathode active materials is between 94 and 97.9 percent, a content of the solid lubricant additive is between 0.1 and 3 percent, a content of the conductive additive is between 1 and 4 percent, and a content of the cathode binder is between 1 and 4 percent.

20. The method of claim 15, wherein the cathode active material layer is calendered to a porosity of between 18 and 25 percent.
